(19) United States
(12) Patent Application Publication
(10) Pub. No.: US 2012/0141904 A1
(43) Pub. Date: Jun. 7, 2012

(54) LOW MASS SOLID OXIDE FUEL DEVICE ARRAY MONOLITH

(75) Inventors: Michael E. Badding, Campbell, NY (US); William Joseph Bouton, Addison, NY (US); Jacqueline Leslie Brown, Lindley, NY (US); Lanrik Kester, Bath, NY (US); Scott Christopher Pollard, Big Flats, NY (US); Patrick David Tepesch, Corning, NY (US)

(73) Assignee: Corning Incorporated, Corning, NY (US)

(21) Appl. No.: 13/379,408

(22) PCT Filed: Jun. 24, 2010
(86) PCT No.: PCT/US10/39739

§ 371 Date: Feb. 9, 2012

Related U.S. Application Data
(60) Provisional application No. 61/220,783, filed on Jun. 26, 2009.

(51) Int. Cl. H01M 8/24; C03B 29/00; H01M 8/10

(52) U.S. Cl. 429/461; 429/482; 429/465; 429/454; 429/458; 156/89.12

(57) ABSTRACT

According to one embodiment of the invention a fuel cell device array monolith comprises at least three planar electrolyte sheets having two sides. The electrolyte sheets are situated adjacent to one another. At least one of the electrolyte sheets is supporting a plurality of anodes situated on one side of the electrolyte sheet; and plurality of cathodes situated on the other side of the electrolyte sheet. The electrolyte sheets are arranged such that the electrolyte sheets with a plurality of cathodes and anodes is situated between the other electrolyte sheets. The at least three electrolyte sheets are joined together by sintered fit, with no metal frames or bipolar plates situated therebetween.

This application claims the benefit of priority under 35 USC 119(e) of U.S. Provisional Application Ser. No. 61/220,783 filed on Jun. 26, 2009.

### BACKGROUND

1. Field

The present invention relates generally to fuel cell array assemblies, and more particularly to the Solid Oxide Fuel Cell device array monoliths.

2. Technical Background

Solid Oxide Fuel Cell (SOFC) systems show promise for highly efficient conversion of hydrocarbon fuels to electricity. Typical SOFC stacks target stationary applications, are large and heavy, and have relatively poor gravimetric power density compared to conventional power generation devices. Conventional SOFC fuel cell device assemblies include large and heavy components such as thick ceramic plates or tubes, metal supports, metal frames, and bipolar plates. Often these components are chosen in order survive thermal strains associated with high temperature operation. As a consequence, gravimetric power density, thermal cycling rate and start-up time performance of the conventional SOFC device assemblies are limited.

### SUMMARY

According to one embodiment of the invention a fuel cell device array monolith comprises:

at least three planar electrolyte sheets having two sides; said electrolyte sheets situated adjacent to one another,

at least one of said electrolyte sheets supporting a plurality of anodes situated on one side of the electrolyte sheet; and plurality of cathodes situated on the other side of the electrolyte sheet; the electrolyte sheets being arranged such that said at least one of the electrolyte sheets with a plurality of cathodes and anodes is situated between the other electrolyte sheets, the at least three electrolyte sheets are joined together by sintered frit, with no metal frames or bipolar plates situated therebetween. Preferably the fuel cell device monolith has an active cell area per unit volume of at least 1 cm²/cm³.

According to one embodiment of the invention a fuel cell device array monolith comprises: at least three planar electrolyte-supported fuel cell arrays, each of said arrays including (i) an electrolyte sheet having two sides; (ii) a plurality of anodes situated on one side of the electrolyte sheet; and (iii) a plurality of cathodes situated on the other side of the electrolyte sheet; said arrays being arranged such that an anode side of one fuel cell array faces the anode side of another fuel cell array and one cathode side of one fuel cell array faces the cathode side of another fuel cell array, and said at least three fuel cell devices (each device may have a plurality of fuel cells arranged on a single electrolyte sheet) are joined together by sintered frit. Preferably, according to some embodiments, the at least three fuel cell arrays share a common gas input port.

Another embodiment of the present invention is a method for producing a fuel cell device monolith comprising the steps of: (i) producing at least three fuel cell devices comprising an electrolyte sheet; (ii) patterning a surface of at lest two of said devices with glass, glass-ceramic or ceramic based material, thereby producing a plurality of patterned devices; (iii) sintering each of said patterned devices to at least one other device so as to permanently attach said three devices to one another with a sintered glass, glass-ceramic or ceramic based material, such that there are no metal frames, metal current distributor plates, or metal bipolar plates situated therebetween.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Some of the advantages of the exemplary embodiments of the SOFC device array monoliths is that they are especially suitable for mobile and portable applications because they are: (i) scalable (the size of fuel cell devices can be scaled up or down), and the number of the devices in device array monoliths can be increased or decreased, based on the application, and (ii) have a substantially reduced mass needed to meet higher demands on gravimetric power density to minimize start-up fuel penalty. That is, some of the advantages of at least some of the exemplary embodiments of the SOFC device array monoliths are their high gravimetric power density and low thermal mass. Another advantage is highly efficient device packing density and with high volumetric power density compared to conventional SOFC stacks at a similar cell power density.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1A is a top view of one embodiment of the present invention;

FIG. 1B is a side view of the embodiment of the present invention illustrated in FIG. 1A;

FIG. 2 illustrates an exemplary fuel cell device utilized in the embodiments of FIGS. 1A and 1B;

FIG. 3 illustrates the average thermal expansion coefficient of an exemplary frit, in both glassy and cerammed states;

FIGS. 4A and 4B illustrate two exemplary frit deposition patterns;

FIG. 4C illustrates the path flow of gasses flowing through frit structures defined by the fit patterns shown in FIGS. 4A and 4B;

FIG. 5A illustrates an exemplary internally manifolded device array monolith;

FIG. 5B illustrates the side view of device array monolith of FIG. 5A;

FIG. 6A illustrates an exemplary extruded Gas Interface Manifold GIM;

FIG. 6B is a cross-sectional view of channels in a green extradite part that was made into the gas interface manifold of FIG. 6A;

FIG. 6C illustrates an exemplary end cap for use with the gas interface manifold of FIG. 6A;

FIG. 7A illustrates frit rings on top of a gas interface manifold of FIG. 6A (top, and an exemplary frit/3YSZ gasket (bottom);

FIG. 7B illustrates the exemplary interface gasket of FIG. 7A bonded to the to the gas interface manifold shown in FIG. 7A;

FIG. 8 illustrates an exemplary device array manifold DAM joined to the exemplary gas interface manifold GIM;

FIG. 9 illustrates schematically another embodiment of the internally manifolded device array monolith DAM that includes 8 fuel cell devices;

FIG. 10 illustrates mass contributions from various components of the exemplary of the device array monolith of FIG. 9;

FIG. 11 illustrates a relationship of gravimetric and volumetric power density vs. cell power density in an exemplary internally manifolded device array monolith;

FIG. 12 illustrates the relationship between frit bead geometry, heat capacity and device spacing in an exemplary internally manifolded device array monolith;

FIG. 13 illustrates the relationship between Start-up fuel penalty and heated stack mass.

### DETAILED DESCRIPTION OF THE PREFERRED EMBODIMENTS

During fuel cell operation, the fuel cell device, seal and metal frame in a typical solid oxide fuel cell system can be subjected to operating temperatures of from about 600° C. to about 1,000° C. In addition, these components can experience rapid temperature cycling during, for example, startup and shutdown cycles. The thermal mechanical stresses placed on these components can result in deformation, fracture, and/or failure of the fuel cell device or the fuel cell stack. The exemplary embodiments of the present invention provide several approaches to minimize such deformation, fracture, and/or failure in fuel cell devices and fuel cell stacks. The various approaches can be used individually or in combination, as appropriate, and the present invention is not intended to be limited to a single embodiment. All of the embodiments described herein are intended to describe embodiments containing an electrolyte, an electrodes and frame. If an element required for fuel cell operation is not specifically recited, embodiments both including and excluding the element are intended and should be considered part of the invention.

Reference will now be made in detail to the present preferred embodiments of the invention, examples of which are illustrated in the accompanying drawings. Whenever possible, the same reference numerals will be used throughout the drawings to refer to the same or like parts.

According to some embodiments of the invention a fuel cell device array monolith DAM 10 (i.e., a monolithic assembly of arrayed fuel cell electrolyte sheets, with one or more electrolyte sheets supporting a plurality of electrodes) comprises:

at least three planar electrolyte sheets having two sides; said electrolyte sheets situated adjacent to one another,

at least one of said electrolyte sheets supporting a plurality of anodes situated on one side of the electrolyte sheet; and a plurality of cathodes situated on the other side of the electrolyte sheet; said electrolyte sheets being arranged such that said at least one of said electrolyte sheets with a plurality of cathodes and anodes is situated between the other electrolyte sheets, said at least three electrolyte sheets are joined together by sintered frit, with no metal frames or bipolar plates situated therebetween. The fuel cell device array monolith DAM 10 may include a plurality of arrayed fuel cell devices. It is noted that at least according to some embodiments the sintered frit provides a sintered frit structure that provides hermetic gas separation between the fuel cell devices.

According to some embodiments of the present invention a solid oxide fuel cell device array monolith (DAM), comprises: (i) at least three solid oxide fuel cell (SOFC) devices, each including an electrolyte sandwiched between at least one pair of electrodes attached to one another by a bonding/sealant material 50 without a metal frame or a bipolar plate situated therebetween. The material 50 is preferably sinterable to a hermetic structure below about 1000° C. Preferably the material 50 is sintered and is bonded directly to the solid oxide fuel cell (SOFC) devices. Preferably, a fuel cell device array monolith DAM includes at least 5 fuel cell devices, each with a plurality of electrodes. Preferably the plurality of electrodes are a plurality of cathodes and a plurality of anodes. More preferably, a fuel cell device array monolith DAM includes at least 8 fuel cell devices.

Thus, according to at least some embodiments of the invention, a method of producing a fuel cell device array monolith includes the steps of:

(i) Arranging the fuel cell device between two electrolyte sheets such that there is a pattern of bonding/sealant material situated between the device and the electrolyte sheets. The bonding/sealant material may be applied on one or both sides of the fuel cell device/ and/or on one or both sides of the electrolyte sheets. The electrolyte sheet may be an electrolyte sheet without the electrodes, or may support electrodes, and thus be a part of another fuel cell device.
(ii) Sintering the bonding/sealant material, thereby attaching the fuel cell device to the electrolyte sheets, or other devices. Several fuel cell devices may be attached in this manner to one another, forming a the device array monolith such that the fuel cell device(s) and/or the electrolyte sheet(s) are attached directly to the sintered sealant material without any other component being bonded to the sintered sealant material. As discussed above, preferably the electrolyte sheet is the electrolyte sheet of another solid oxide fuel cell device, so that at least two fuel cell devices are bonded to one another by the sealant material without having a metal frame situated therebetween. It is also noted that the two fuel cell devices may be patterned with the bonding material (also referred as a sealant material herein) 50 and placed on top of one another so that the sealant material of one device faces the sealant material of another device. The two patterns made of the sealant material 50 may be in contact with one another.

According to at least some embodiments of the present invention bonding material 50, for example glass, ceramic, or glass-ceramic frit is applied in a predetermined pattern on the surface of a plurality fuel cell devices to manufacture a SOFC device array monolith made of at least three electrolyte sheets and preferably including three or more fuel cell devices. Such frit may be applied by any of the conventional means such as through a molding process or via robotic paste deposition described later in the specification. The bonding material is applied, for example, to the electrolyte sheet section of the fuel cell devices. The bonding material(s) 50 may include glass, glass ceramic, or ceramic materials, or combinations thereof, including optional metal or ceramic fillers, wherein the resultant material or composite of materials 50 is sinterable to a hermetic structure below about 1000° C.

Substantially planar fuel cell devices with multiple electrodes may be arranged in such a way as to provide a common gas chamber between two adjacent devices. For uniform gas flow, the spacing between fuel cell devices, defining the chamber, is preferably on the order of millimeters (e.g., 1 mm-8 mm, or 1 mm-5 mm). Separation on the millimeter scale is easily achieved with the resulting sintered material (e.g., sintered glass-ceramic frit). Thus, sintered frit may be used as a spacer element within such a device array, without the need for a structurally separate construction component, such as a metal window frame. The fuel cell devices are fabricated in such a way as to provide non-active areas corresponding to the required frit pattern. That is, the bonding material 50 is preferably applied to the non-active areas of the fuel cell device (e.g., on the electrolyte sheet). For example a significant perimeter area of the electrolyte sheet may be left unprinted (i.e., not having printed electrodes) to provide non-active area for creation of gas passage structures about the perimeter of the device. According to at least some embodiments, in order to create the device array monolith, fuel cell devices (each preferably with multiple electrodes) are fabricated first. These devices are the starting “substrates” whereupon simple or complex patterns of bonding material, for example glass-ceramic frit paste, are deposited in a specific pattern. This pattern of glass-ceramic frit paste (or of another suitable material) is designed to provide required sealing functions, mechanical support functions, and gas distribution functions. For example, the frit is used to create structural elements patterned to provide manifolding functionality. At least three devices are joined with frit or another suitable bonding material to create a fuel cell device array monolith by co-sintering a plurality of devices with frit patterns in such a manner as to join them to one another. After sintering, the fuel cell device array monolith as a whole is mechanically integral (monolithic), and has required gas input and output ports available on at least one edge or face of the monolith. In a preferred embodiment, the array is constructed of more than three fuel cell devices, preferably at least four.

According to exemplary embodiments, an SOFC device array monolith advantageously has a low mass structure, which is achieved due to the elimination of the typical structural components required for conventional SOFC designs (e.g., such as window frames, cell support tubes, and/or bipolar plates). Low mass, and consequently, low thermal mass, provides high gravimetric power density, improved thermal-mechanical robustness, improved thermal cycle rate capability, and lowers the energy required to heat the device array monolith to operating temperature.

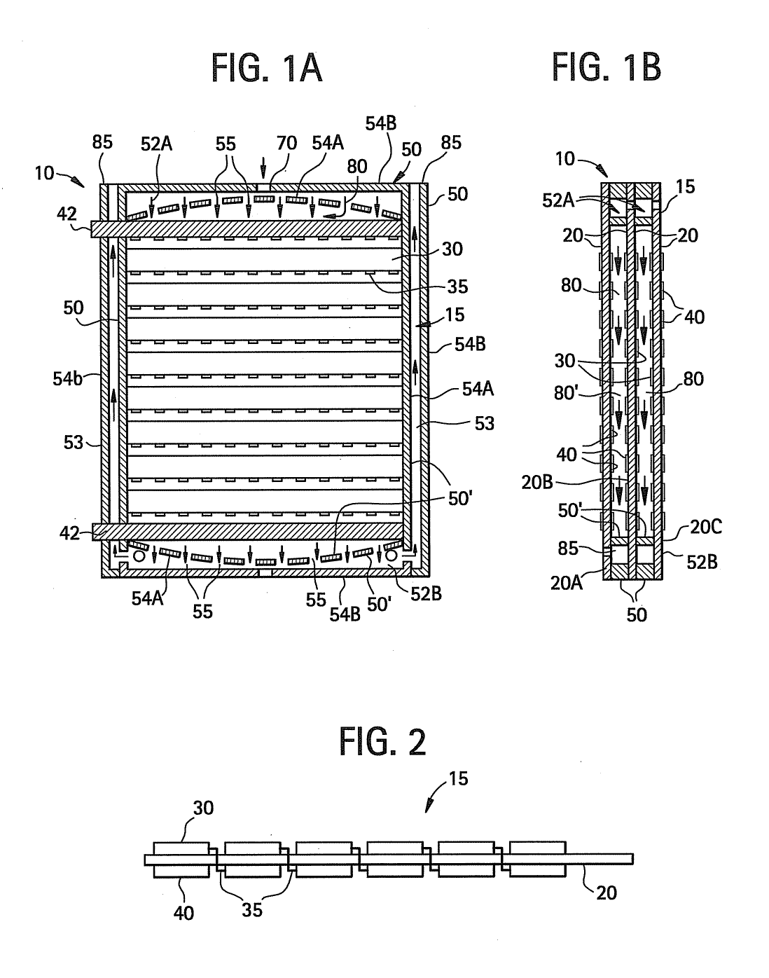

FIGS. 1A and 1B illustrate a fuel cell device array monolith 10 that includes at least one fuel cell device 15 with a structure of sintered glass, ceramic, or glass-ceramic material (e.g., frit) situated thereon. The fuel cell device array monolith 10 includes at least one reaction chamber 80, formed at least partially by the fuel cell device(s) 15 and the sintered glass, ceramic, or glass-ceramic material 50. Other bonding/sealant materials that can survive high temperatures may also be utilized. The fuel cell device(s) 15 may be, for example, single cell devices (not shown), or multi-cell devices (see FIG. 2, for example). According to one embodiment, the three fuel cell devices patterned with the bonding material (see FIGS. 1A-1B) are sintered and bonded to one another to form two reaction chambers (a fuel (or anode) chamber 80 and an oxidant (or cathode) chamber 80′). For example, the three fuel cell devices 15 shown in FIG. 1B are directly bonded or fused to each other by the sintered material 50 that is printed on at least one or two, and preferably all three fuel cell devices 15 and thus, in conjunction with the sintered material, form an anode or fuel chamber 80 on one side of the central fuel cell device 15, and an oxidant or cathode chamber on the other side of the central fuel cell device 15. For example, the bonding material may be deposited on both sides of the central fuel cell device 15, the two adjacent fuel cell devices 15 can then be placed under and over this central fuel cell device, and the entire assembly can then be sintered to form a fuel cell device array monolith 10. Alternatively, all three fuel devices my have the bonding material deposited on at least one of the sides that would be facing the other device, placed on top of one another, and then sintered. The sintered material 50 also serves as a gas-tight (hermetic) seal and may be made, for example, of conventional heat-sinterable glass-ceramic sealing compositions.

As stated above, the electrolyte sheets 20 are connected to one another and are separated from one another by the structure formed by the bonding material 50 (See FIGS. 1A-1B), which in these embodiments is also sealant material. Therefore, one of the advantages of the embodiments of the present invention is that no metal frame needs to be utilized to support the fuel cell devices and to form reactant chambers therebetween, and no bipolar plates are needed. Another advantage is that the fuel cell device array monolith 10 is relatively small, very light weight, and has low thermal mass (because no bulky metal frame is required to support fuel cell device(s), and because there are no separators or bipolar plates that are situated between the fuel cell devices 15). Another advantage is that the sintered bonding material(s) and the electrolyte(s) can now have very similar coefficients of thermal expansion (CTEs), thus providing a very robust thermo-mechanical SOFC assembly that does not delaminate and does not crack during thermal cycling at the seal/device interface due to CTE mismatches. In addition, the fuel cell devices 15 can be situated in very close proximity to one another resulting in high packing density (for example 1-3 mm separation) within the fuel cell device array monolith 10, resulting in the monolith's compactness and uniform heating (due to very low temperature gradients across the fuel cell device array monolith. Other advantages of the fuel cell stack 10 according to some at least embodiments are: low mass and portability and good gravimetric power density (our modeling indicates that the monolith's gravimetric power density of 1 kW/kg or better is achievable). Because this planar technology is scalable, such a high gravimetric power density would enable a new class of portable power supplies which advantageously can: (i) run on conventional hydrocarbon fuels; (ii) have low thermal mass; (iii) rapid start-up (1 to 15 minutes), this is because mass is an important design parameter determining short start-up time capability and low mass results in a short start-up times; (iv) reduced start-up fuel penalty (i.e., energy required to heat the DAM to its operating temperature), because the energy (fuel) required to heat the monolith to its operating temperature is directly proportional to the monolith's mass, (v) have high volumetric power density, because separation between the electrolyte sheets is set only by the thickness of the seal, allowing a very high active cell area to monolith's volume ratio; (vii) improved thermal mechanical integrity (low mass structures can be made with flexible, low modulus elements that can manage thermal mechanical strains without failure); (viii) reduced cost and less material (e.g., no frame cost, cost of bipolar plate is eliminated); and/or (ix) reduced contamination (for example, cathode contamination from volatile chromic species is not an issue of concern).

An exemplary fuel cell device 15 (See FIG. 2) includes ceramic electrolyte sheet 20 sandwiched between at least one anode 30 and at least one cathode 40, and may include one or more bus bars 42. As shown in FIG. 2, the anodes and cathodes may be electrically interconnected by conductive via interconnects 35 that extend through via holes in the electrolyte sheets 20. The ceramic electrolyte 20 can comprise any ion-conducting material suitable for use in a solid oxide fuel cell. More specifically, via interconnects 35 preferably traverse the electrolyte sheet 20 from the extending edge of each anode 30 on the interior or fuel side of the electrolyte sheet to the extending edge of the next succeeding cathode in sequence (situated on the air side of the electrolyte sheet), as best illustrated in FIG. 2. Thus, the embodiment of the fuel cell device 15 shown in FIG. 2 includes: (i) at least one electrolyte sheet 20; (ii) a plurality of cathodes 40 disposed on one side of the electrolyte sheet 20; (iii) a plurality of anodes 30 disposed on the other side of the electrolyte sheet.

For example, the fuel cell device assembly shown in FIGS. 1A-1B includes three fuel cell devices 15 attached to one another via the bonding/seal material 50, wherein each of these devices includes an electrolyte sheet that supports a plurality of cathodes and anodes. The electrolyte sheets are bonded or fused directly to the to the sintered material 50 and are oriented to enable reactant flow through the frame and between the electrolyte sheets, such that either (i) anodes situated on the first electrolyte sheet face anodes situated on the second electrolyte sheet (forming a fuel or an anode chamber 80), or (ii) cathodes situated on the first electrolyte sheet face cathodes situated on the second electrolyte sheet (forming an oxidant or cathode chamber 80′). Preferably the fuel cell devices (i.e., the combined thickness of the electrolyte and electrodes), are less than 150 μm thick and the separation between the two devices (i.e., frame thickness) is less than 3 mm, and preferably between about 1 mm and 2 mm.

The electrodes 30, 40 can comprise any materials suitable for facilitating the reactions of a solid oxide fuel cell, such as, for example, silver/palladium alloy. The anode and cathode can comprise different or similar materials and no limitation to materials or design is intended. The anode and/or cathode can form any geometric pattern suitable for use in a solid oxide fuel cell. The electrodes can be a coating or planar material positioned parallel to and on the surface of the ceramic electrolyte. The electrodes can also be arranged in a pattern comprising multiple independent electrodes. For example, an anode can be a single, continuous coating on one side of an electrolyte or a plurality of individual elements, such as strips, positioned in a pattern or array.

An anode 30 can comprise, for example, yttria, zirconia, nickel, or a combination thereof. A large variety of other electron and ion conductors as well as mixed electron and ion conductors can also utilized. They are, for example, lanthanum gallates, zirconia doped with ceria or other rare earths, singly or in combination, copper, iron, cobalt and manganese. An exemplary anode can comprise a cermet comprising nickel and the electrolyte material such as, for example, yttria-doped zirconia.

A cathode 40 can comprise, for example, yttria, zirconia, manganate, cobaltate, bismuthate, or a combination thereof. Exemplary cathode materials can include, yttria stabilized zirconia, lanthanum strontium manganate, and combinations thereof.

The electrolyte 20 can comprise a polycrystalline ceramic such as zirconia, yttria, scandia, ceria, or a combination thereof, and can optionally be doped with at least one dopant selected from the group consisting of oxides of Y, Hf, Ce, Ca, Mg, Sc, Nd, Sm, Eu, Gd, Tb, Dy, Ho, Er, Tm, Yb, Lu, In, Ti, Sn, Nb, Ta, Mo, W, or a mixture thereof. The electrolyte 20 can also comprise other filler and/or processing materials. An exemplary electrolyte 20 depicted in FIG. 2 is a planar sheet comprised of zirconia doped with yttria, also referred to as yttria stabilized zirconia (YSZ). Solid oxide fuel cell electrolyte materials are commercially available (Ferro Corporation, Penn Yan, N.Y., USA) and one of skill in the art could readily select an appropriate ceramic electrolyte material.

In these embodiments the material 50 is bonded directly to the fuel cell device(s) 15. For example, the material 50 can be molded, deposited on, squeezed onto, or “painted” or “printed” on the electrolyte 20 and can comprise a glass ceramic composition, ceramic composition, glass frit composition, or a glass composition. It is preferable, in order to provide a seal and/or internal manifolding that the deposited material 50 be less than 3 mm thick, preferably less than 2 mm thick and less than 2 mm wide. It is preferable that the deposited material 50 be less than 3 mm wide, preferably less than 3 mm thick and less than 2 mm wide. However, the deposited material 50 can be also be spread on the electrolyte sheet in areas of high stress, over widths wider than 3 mm, providing improved structural integrity to the fuel cell device. The material 50 is fused to a plurality of cell device(s) 15 by fusing the material directly to the electrolyte sheets(s) 20. The material 50 may include a glass or glass-ceramic frit and can further comprise ceramic materials and/or coefficient of thermal expansion matching fillers. Advantageously, the sintered structure formed of material 50 (comprising a glass frit, ceramic material, or another suitable “sealing” material) does not suffer from formation of chromia scales typically formed by ferritic stainless steel fuel cell components (e.g., stainless steel frames or stainless steel bipolar plates). The sintered structure formed of material 50 acts as a seal, and no additional seals or frames between the frame and fuel cell device(s) are thus required by the fuel cell device array monolith 10.

It is preferable that the sintered bonding structure formed by material(s) 50 have CTE close to that of the electrolyte sheet 20, in order to provide expansion comparable to that of the electrolyte sheet 20. If the electrolyte sheet 20 is made of partially stabilized zirconia (e.g., 3YSZ), it is preferable that the material 50 has CTE (CTE=ΔL/LΔT) of about 9 to 13 ppm/° C. and preferably 10 to 12 ppm/° C. Such CTE's may be realized for example, with ceramic compositions within the magnesia (MgO)-spinel (MgAl₂O₄) system, or if material 50 includes 3YSZ or another partially stabilized zirconia composition.

FIGS. 1A-1B also illustrate that the sintered material 50 may form multiple chambers, such as one or more “biscuit shaped” gas expansion chambers 52A. These chambers are utilized to provide the required reactant to the anodes and/or cathodes. Distribution chambers (such as gas expansion chambers 52A in this embodiment) help to evenly distribute gas flowing into reactant chamber via inlet orifices), while exit chambers 52B provide expanded zones for the collection of exhaust fuel into final outlets. The wedged or “biscuit” shape of the gas expansion chambers add sufficient frictional drag to ensure uniform flow.

The sintered structure formed of material 50 shown in FIGS. 1A-1B has a plurality of internal walls 54A and external walls 54B. Some of these walls are optional, a single external perimeter wall design will also be functional. The walls are produced, for example, by (i) molding the green electrolyte sheet with the appropriate “wall” structure made out of the electrolyte sheet material (3YSZ, for example), or (ii) by depositing a layer (e.g., thin tubular layer) of the appropriate bonding material (sealant material) 50 on the electrolyte sheet 20 of at least one fuel cell device 15 (and preferably on the electrolyte sheet 20 of the plurality cell devices 15), and placing each electrolyte sheet 20 in contact with this sealant material, and then heat treating the resultant fuel cell device assembly to fuse the electrolyte sheets 20 to the resultant seal structures formed by the material 50, and thus bonding the plurality of the fuel cell devices to each other. Some of the internal walls 54A (formed by the material 50) have openings 55 to allow the fuel to flow into the reactant chamber and be in contact with the anodes. In this embodiment, the fuel passes (see direction of arrows) through the fuel inlet orifice 70 and in between pairs of adjacent devices 15, and then through the gas expansion chamber 52A to the anode chamber 80 foamed by the electrolyte sheets 20 (sheet 20ₐ and 20_{b}). The fuel then flows through the second set of openings 55 into the exhaust flow chamber 52B, and is then exhausted via exhaust (fuel) orifice 85. In this embodiment the exhaust orifices 85 are located on the section of the frame 50 situated furthest from the fuel inlet orifice 70 (exhaust side). Similarly a cathode chamber (oxidant chamber) will be formed by two adjacent electrolyte 20 sheets (sheet 20_{b} and 20_{c}). Of course more than 3 fuel cell devices may be permanently attached in this manner, forming a monolithic fuel cell device array monolith 10.

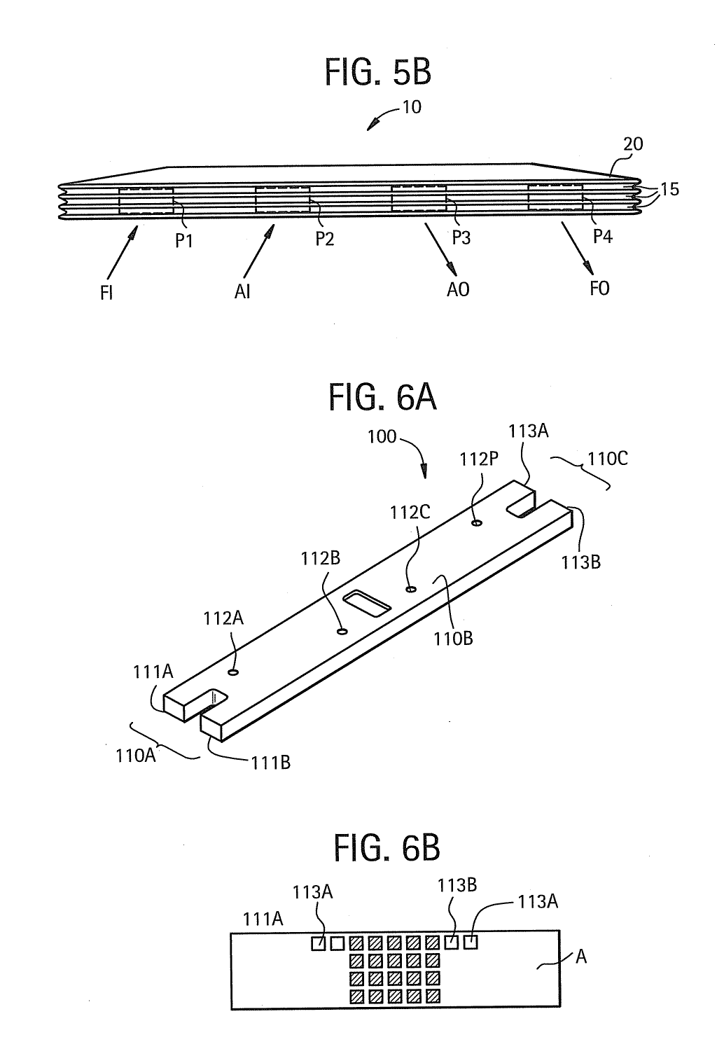

For example, a device array monolith of ten fuel cell devices 15, each attached to at least one other adjacent fuel cell device via sintered sealant material 50 situated therebetween will have nine reactant chambers. These reactant chambers are alternating oxidant and fuel chambers 80, 80′. It is also noted that instead using fuel cell devices 15 situated at the front and the rear sides of the device array monolith one may utilize two electrolyte sheets (without printed electrodes), these electrolyte sheets would be bonded/sealed by the material 50 to their respective adjacent fuel cell device to form the first and last reactant chambers. The resultant fuel cell device array monolith 10 includes no metal frames, no additional separator plates and no bipolar plates between the fuel cell devices. Preferably, at least a plurality of fuel cell devices share a single fuel inlet, and/or single fuel inlet, and/or a single oxidant inlet and/or a single oxidant outlet. Preferably, all of the fuel cell devices share a single fuel inlet (Port P1), a single fuel outlet (Port P4), a single oxidant inlet (Port P2), and a single oxidant outlet (Port P3), (see FIG. 5B). For example, all four ports (2 inlets i and 2 outlets) may be conveniently located on one side of the monolithic fuel cell device array monolith. The terms “single fuel inlet”, “single fuel outlet”, “a single oxidant inlet”, and/or “a single oxidant outlet” refer to inlets and outlets of a device array monolith (DAM) 10. Of course more than one device array monolith fuel inlet or outlet and more then one monolith oxidant inlet or outlet may also be utilized.

The sealant/bonding material 50 may form a structure that may also include a plurality of channels 53 formed by the external frame walls 54B and the internal frame walls 54A, which can also be utilized as a heat exchanger, to minimize temperature gradients on the fuel cell device(s) 15. Thus, FIG. 1A illustrates that internal manifolding for the supply of reactant gases (fuel and/or air) for the fuel cell device array monolith 10 may be provided internal to the frame 50 by providing flow channels 53 between the frame walls 54A and 54B. Channels 53 provide means for partial preheating of the inlet reactant gas(s) entering the reactant chamber 80 and help to ensure uniform heating of the multi-cell devices 15. The direction of reactant (e.g., fuel) flow within the fuel cell device array monolith of this embodiment is indicated by the arrows. Fuel is fed to the fuel cell device(s) 15, for example, through the fuel inlet orifice 70. The fuel passes (see direction of arrows) from fuel inlet orifice 70, through the flow chamber 52A, to the anode chamber 80 formed by the two electrolyte sheets, into the exhaust flow channels 52B, and is then exhausted via exhaust flow chamber 52B and the exhaust flow channels 53 through exhaust apertures 85. Making the bonding material 50 form a sintered structure with multiple channels 53 or chambers with openings 55 as shown in FIG. 1B provides the advantage of having a multiple channels for reactant flow, while reducing the sintered structure's density and increasing the surface area due to its high OFA (open frontal area). Because the sintered material 50 utilizes thin external and internal walls spaced apart from each other, the sintered structure between the electrolyte sheets is relatively light and thermally conductive. Accordingly, this type of structure facilitates good gas flow and heat exchange between incoming fuel and spent fuel.

Several exemplary compositions of glass-ceramic frit bonding materials 50 are provided in the Table 1 below. Preferably the thermal expansion coefficients of the bonding materials 50 is in the range of 10.5 to 11.5 ppm/° C. These exemplary compositions can be utilized in any of the embodiments disclosed herein.

TABLE 1

| Component | 129 | 129 | 129 | 129 | 129 | 129 | |
|---|---|---|---|---|---|---|---|
| (wt %) | NYD | NUW | NUC | NTR | NUF | OEN | 116 QH |
| SiO2 | 50.2 | 53.2 | 44.0 | 39.2 | 27.4 | 29.2 | 35.9 |
| Al2O3 | 5.0 | 5.0 | 7.4 | 2.9 | 3.8 | 5.6 | |
| CaO | 28.6 | 39.4 | 33.0 | 24.5 | 15.3 | 50.4 | 16.0 |
| MgO | 8.0 | 7.4 | | | | | |
| SrO | 13.2 | | 15.6 | | 22.8 | 11.9 | 23.5 |
| Nb2O5 | 2.5 | | | | | | |
| BaO | | | | 33.4 | 30.7 | | 21.1 |
| ZnO | | | | | | 2.9 | |
| TiO2 | | | | | | | 3.4 |

If no numerical value (for wt %) is present in the Table 1 for one or more components of a given bonding material composition, this component(s) is not present in significant amounts. That is the corresponding wt % of this component is less than about 0.1 wt %, and preferably 0 wt %. For example, the first exemplary composition (composition 129 NYD) comprises essentially no BaO, ZnO or TiO₂.

### Exemplary Frit Preparation

The desired composition is melted, typically at 1600° C. for 3 hours, poured, solidified, crushed, and coarse-milled to prepare a +325 to −20 mesh feedstock. The feedstock is ball milled in an alumina jar with alumina media to achieve a D₅₀ between 10 and 15 microns as measured on a Coulter counter. After reaching the desired D₅₀ target, the frit is sieved at −200 mesh to remove large particles.

Exemplary paste preparation: Frit pastes can be made with conventional binders and solvents. Exemplary binders include ethyl cellulose, polypropylene carbonate, and poly vinyl butyral of various molecular weights in appropriate solvents. Table 2, below, discloses an exemplary paste vehicle based on ethyl cellulose (3.7 wt % ethyl cellulose vehicle).

TABLE 2

| Amount | | | |
|---|---|---|---|
| (g) | Component | Manufacturer | Function |
| 1000 | Texanol ® (2,2,4- | Acros | solvent |
| | Trimethyl-1,3-pentanediol | | |
| | mono (2-methyl propanoate) | | |
| 90.48 | Anti Terra 204 | BYK Chemie | dispersant |
| 42 | Ethyl Cellulose T-100 | Hercules Avalon | binder |

The exemplary frit pastes are typically batched as 50-65 volume % glass ceramic powder and 50-35 volume % vehicle. The vehicle and the flit are mixed with a planetary mixer for thorough mixing of the components to form the finished frit paste.

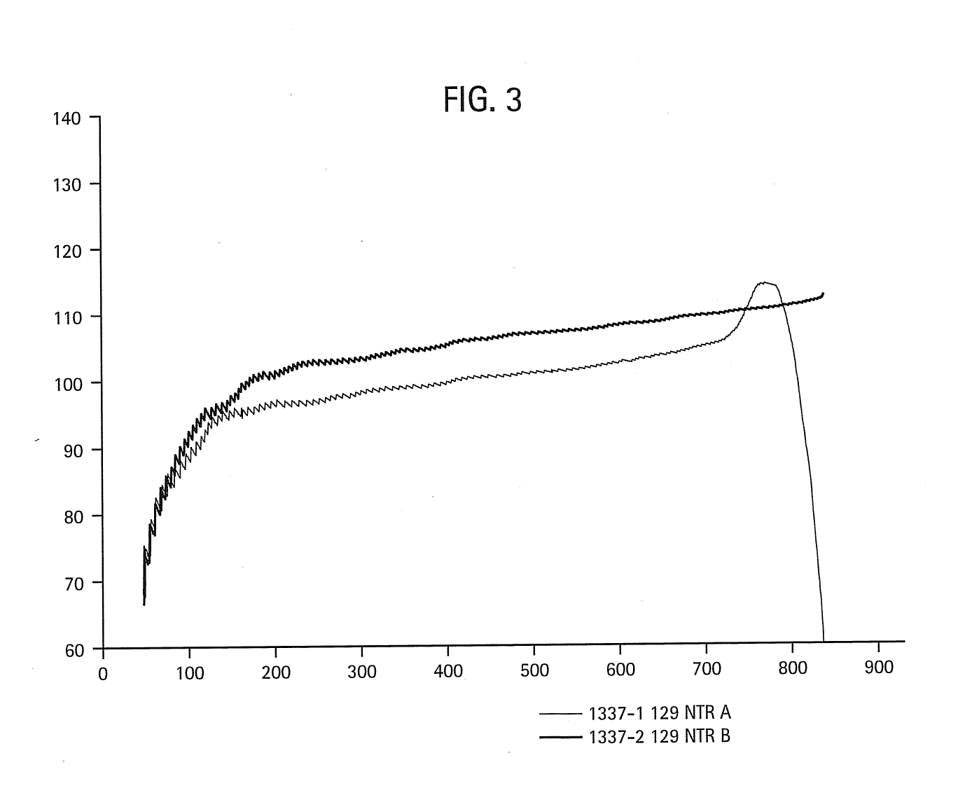

FIG. 3 illustrates the average thermal expansion coefficient for the cerammed (flit) composition designated 129NTR (see example 4 of Table 1). A frit bar A fired at 825° C. for 2 hours shows glassy behavior with a glass transition dilation peak followed by softening. Crystallization occurs upon extended heating at 825° C. A frit bar B fired at 825° C. for 72 hours shows no evidence of a glass transition, indicating the frit bar is substantially crystallized. The SOFC device array monoliths 10 have excellent thermal mechanical robustness with fully crystallized frit when the crystallized material has an expansion well matched to the YSZ electrolyte. The average coefficient of thermal expansion for 3YSZ, for examples, is 110×10⁻⁷/° C. at 750° C.

### EXAMPLES

The invention will be further clarified by the following example(s).

### Example 1

This example illustrates an ultra-low thermal mass fuel cell device array monolith 10 utilizing a plurality of frit bonded fuel cell devices.

### SOFC 4-Port Monolith.

The following is a description of the process for fabrication of one embodiment of the SOFC device array monolith 10. The SOFC device array monolith 10 of this embodiment is an internally-manifolded monolith comprising of two fuel cell devices sandwiched between blank electrolyte sheets.

First, we fabricated two planar, mechanically flexible, multi-cell fuel cell devices 15 similar to that shown in FIG. 2. In this exemplary embodiment, the dimensions of the fuel cell devices 15 are 12 cm×15 cm. The fuel cell devices 15 have an unprinted border (i.e., at least a portion of the border boarder has no electrodes, or bus bars) available for deposition of patterned frit (material 50), so that material 50 does not contact the active electrode regions. Steps to fabricate the monolith (fuel cell device array monolith 10) were as follows:

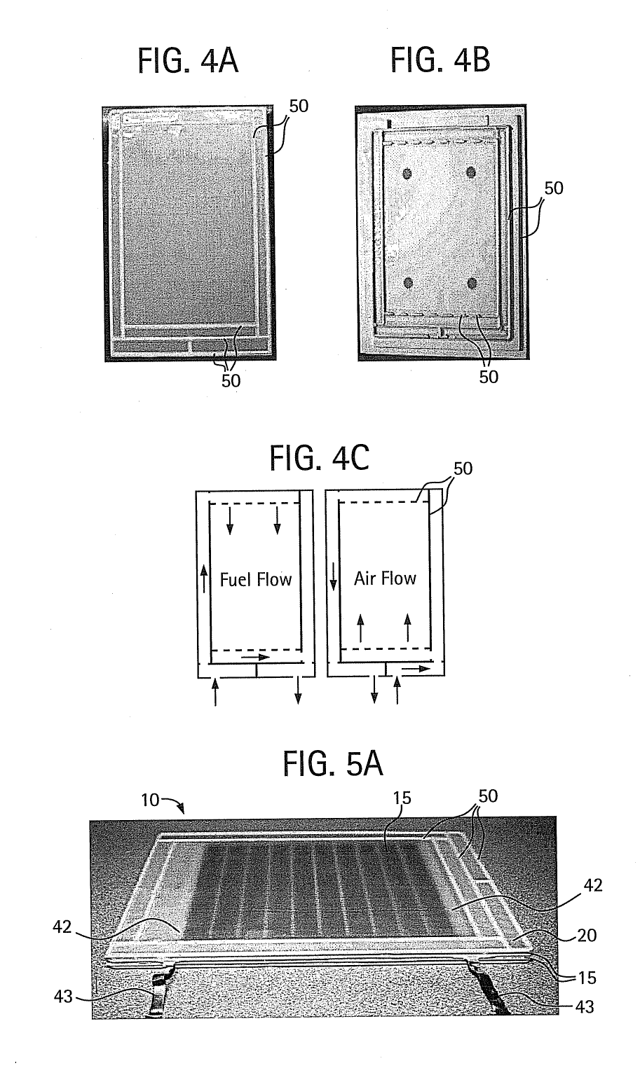

1) A continuous line of material 50 (in this embodiment, frit paste) was applied to one side of the fuel cell devices 15 by robotic dispensing in the pattern shown in FIG. 4A. This pattern is identical on both sides of the devices, in order to help maintain device planarity. In order to avoid, during handling, the formation of defects in the deposited layer of fit paste, the fuel cell devices 15 with the wet flit paste were turned over and placed on a setter board. The setter board had machined channels in order to accommodate the wet frit without contact. A second layer of material 50 (in this embodiment, same frit paste) was then applied in the same pattern shown in FIG. 4A to the other side of the fuel cell devices 15. For fuel cell devices with thin flexible electrolyte sheets, it is preferable to provide symmetric and continuous layers of material 50 on both sides of the fuel cell device in order to help maintain a uniformly planar (not curved) fuel cell devices. The fuel cell devices 15 with the continuous pattern of material 50 are then dried for 15 minutes at 120° C. Once dry, the patterned fuel cell devices 15 were placed between two pieces of a zirconia felt material. On top of the top piece of a zirconia felt material, a 180 g dense alumina setter was placed as weight to help maintain device planarity. The fuel cell devices were then fired to sinter the material 50 (e.g., frit pattern) according to the heating schedule required to achieve desired properties. During the sintering, weight was applied to the fuel cell devices, in order to help maintain devices' planarity.

2) Additional DAM layers were processed as described in step 1). For example, we applied the frit paste the pattern shown in FIG. 4A to two sides of two flexible 3YSZ blank sheets of the same height and width (e.g., 12 cm×15 cm). The two electrolyte sheets 20 were then fired as described above. Thus, we obtained two fuel cell devices 15 and two blank 3YSZ sheets that have sintered layers of material 50, in the pattern shown in FIG. 4A.

3) The discontinuous frit pattern shown in FIG. 4B of material 50 was then deposited directly one side (on top of the previous patterned and fired layer) of blank 3YSZ sheets.

4) Each of the fuel cell devices 15 was carefully mated to the blank 3YSZ sheet that has the pattern of FIG. 4B (resulted from step 3), taking care to ensure that the cathode side of the fuel cell device 15 faces the side of the blank 3YSZ sheet that has the discontinuous pattern shown in FIG. 4B. With the fuel cell devices facing upwards, a small amount of material 50 (e.g., frit paste) is used to join two silver tabs 43 to the fired frit layer, each of the silver tabs (also referred to as leads herein) is electrically connected to one of the device' busbars 42 situated on the cathode side of the fuel cell device. (In this embodiment the bus bars 42 did not extend past the edges of the fuel cell devices). A weight is applied to provide better physical contact between the silver tabs, frit, and the bus bars. Then the device/electrolyte sheet pairs were fired to sinter the frit (applied in the discontinuous pattern) therebetween. Thus, we formed sintered fuel cell devices/electrolyte sheet pairs with a sintered discontinued frit pattern between the fuel cell devices and the blank electrolyte sheets. The sintered pattern of FIG. 4B, in conjunction with the fuel cell device(s) provides reactant gas flow passages, gas manifolds; restrictions for improving gas flow uniformity, and gas input and output orifices between the fuel cell device(s) and/or between a fuel cell device(s) and blank electrolyte sheet(s).

5) A discontinuous frit layer was applied to the exposed device side (anode side) of each device/electrolyte sheet pair on top of the existing fired layer of the continuous frit pattern. In this embodiment, the discontinuous pattern of FIG. 4B was used again.

6) A small amount of silver-palladium paste was applied to provide for electrical contact between the silver leads and the device busbars on both of the (device/electrolyte) sheet pairs.

7) The two device/electrolyte sheet pairs were carefully mated (aligned on top of one another), taking care to ensure that the anode sides of the exposed devices face each other, forming a device array. The unfired discontinuous pattern of the frit was situated in between the two pairs. The device array was then fired, forming a device array monolith comprising two centrally located fuel cell devices and blank electrolyte sheets situated at the opposing sides of the monolith.

The device array monolith DAM is now complete. It is sealed on three sides, with four ports on the bottom edge for fuel and air inlet and exhaust. The path flow of gasses defined by the frit is shown in FIG. 4C. The four ports are: the single fuel inlet (port P1), the single fuel outlet (port P4), the single oxidant inlet (port P2), and the single oxidant outlet (port P3), (see FIG. 5B)

The DAM of this embodiment was fabricated using a glass-ceramic frit with the 128 NTR composition (see Example 4, on Table 1). Firing steps were performed at a temperature of 825° C., for 2 hours. The completed DAM is shown in FIGS. 5A and 5B.

Alternatively, each of the fuel cell devices and electrolyte sheets can be patterned with a continuous pattern of bonding material 50 and sintered. Then the discontinuous pattern of the bonding material 50 (e.g., frit) can be applied to devices and/or electrolyte sheets, so that when the fuel cell deices and electrolyte sheets are stacked on top of one another, there is a discontinuous pattern of the bonding material between the two fuel cell devices, and between the fuel cell devices and the blank electrolyte sheets. The device array monolith can then be fired to sinter the discontinuous pattern of bonding material 50, forming a device array monolith 10. The resultant device array monolith DAM is sealed on three sides, with 4 ports P1, P2, P3, P4 situated on the bottom edge for fuel and air inlet and exhaust. The path flow of gasses defined by the frit is shown schematically in FIG. 4C.

### Gas-Interconnect Manifold

In order to provide for the supply of oxidant and reductant gases to the device array monolith DAM 10, and, optionally, to provide for the capture of exhaust gasses, a Gas Interface Manifold (GIM) 100 is mated to one edge or one face of the device array monolith DAM. The Gas Interface Manifold 100 is at least fed by supply gasses through supply tubing 98A mated to the gas-interconnect manifold at one end or face 110A, and, further, the Gas Interface Manifold is mated to the device array monolith DAM 10 at another end or face 110B. In this embodiment the exhaust gases can exit the Gas Interface Manifold (GIM) 10 through supply tubing 98B mated to the gas-interconnect manifold at the other end or face 110C. The Gas Interface Manifold 100 may be designed to include other desirable functions, for example to provide heat exchange and/or reforming functions and can be made of said gas interface manifold is made glass, ceramic or glass-ceramic extrudate. It is desirable for the Gas Interface Manifold 100 to be made in as low mass configuration as possible, while still providing sufficient mechanical integrity, to allow for the best possible thermal mass match between the device-array monolith and the gas-interconnect manifold.

The extruded Gas Interface Manifold 100 of this embodiment is appropriate for mating with the device array monolith 10 described in Example 1. It was manufactured in the following manner:

1. First, an extrusion batch of 3YSZ material with 3% by weight methycellulose binder was mixed with water to a consistency appropriate for extrusion. The batch was then ram extruded through a die, for example a 200 cell per square inch die with 16 mil spacing between the pins. A rectangular mask was placed in front of the die to form a “200/16” green extrudate comprising a rectangular extrudate 1.25″×0.25″ in cross-section. Parts were cut into 8″ long sections.

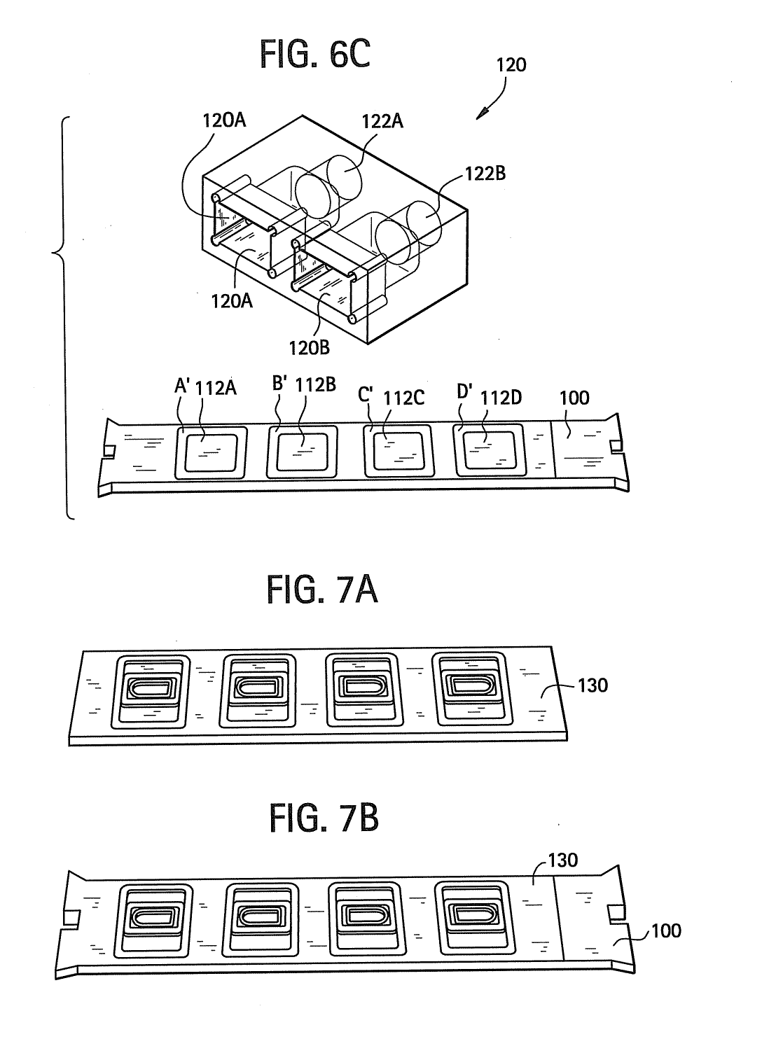

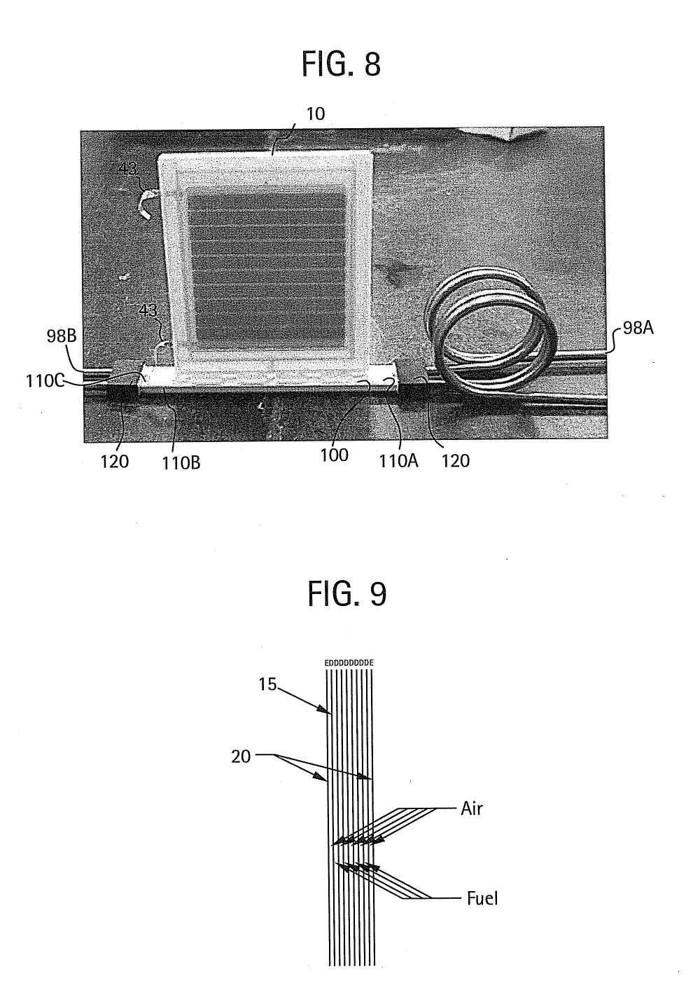

2. After extrusion and drying, the part was machined in the green state to create the Gas Interface Manifold 100 shown in FIG. 6A. Channels on side A (front face) of the green part are plugged in the pattern shown in the front face FIG. 6B. Side A of the green part corresponds to the side 110A (front side) of the GIM 110.

3. At the midpoint of the extrudate part, a cutout was made, and all channels in the cutout were plugged in order to provide a gas tight barrier between the inlet channels and exhaust channels. Then the four openings 112A, 112B, 112C, 112D were made on side B (top side) of the machined part. After machining, the part was fired to 1450° C. to sinter to full density, resulting in a completed Gas Interface Manifold 100. The Gas Interface Manifold 100 includes a side 110A (front side), with openings 111A for incoming fuel gas(s) and openings 111B for the incoming oxidant gas(s). The four openings 112A, 112B, 112C, 112D on the side 110B (top side) of the Gas Interface Manifold can be mated to the 4 ports P1, P2, P3, P4 (fuel inlet FI, and air inlet AI; and two outlets FO, AO that are they fuel and air exhaust ports) situated on the bottom edge of the DAM 10 described in Example 1. The Gas Interface Manifold 100 also includes side 110C (back face), with openings 113A for exhausted fuel gas(s) and openings 113B for the exhausted oxidant gas(s).

### Endcaps

Endcaps 120 shown in FIG. 6C were fabricated next. In this embodiment the endcaps were machined out of stainless steel (446 SS). Other materials may (e.g., ceramic, or glass ceramic) may also be utilized. Typically, coatings to mitigate chromia volatization from the surface of the metal are required for operating SS component in the high temperature SOFC environment. In the Example 1 embodiment, the GIM 100 was designed to operate with endcaps that are at a lower temperature than the DAM 10. If the operating temperature of the steel of endcaps is less than about 600° C., as in the present embodiment, chromia volatization is substantially reduced, without the need for a coating that mitigates chromia volatization.

The endcaps 120 can be mated to the Gas Interface Manifold 100 using an appropriate material, for example a glass or glass-ceramic frit. In this example, the frit material was alumina boro-silicate frit. The use of a boron-containing frit is “allowed” in this case, because the endcaps' operating temperature in this embodiment was specified as less than 600 C. The glass frit was applied in a paste to hermetically seal one of the endcaps to the end protrusions on side 110A of the Gas Interface Manifold 100, such that openings 111A and 111B of the Gas Interface Manifold 100 were mated to the corresponding openings 120A, 120B of the endcup 120. Similarly, the glass frit was applied in a paste to hermetically seal another endcap 120 to the end protrusions on side 110C of the Gas Interface Manifold 100 (with openings 113A and 113B mating to the openings 120A and 120B of the endcaps). The endcaps/Gas Interface Manifold 100 assembly was fired at 850° C. to sinter the frit and to bond the two endcaps 120 to the Gas Interface Manifold 100.

### Joined DAM GIM Assembly

The Device Array Monolith DAM 10 and Gas Interface Manifold 100 were also bonded together. To facilitate the bonding, an adaptor gasket 130 was first fabricated in the design shown in FIG. 7A out of BaO—Al₂O₃—SiO₂ frit used in making the 4 port DAM 10 of Example 1. The frit paste was applied on both sides of a rectangular 3YSZ membrane in a pattern corresponding to that shown in FIG. 5C and fired at 900° C. for 2 hours to completely crystallize the bonding material (in this embodiment BaO—Al₂O₃—SiO₂ frit). In order to join the Device Array Monolith (DAM 10) and the Gas Interface Manifold (GIM 100), the following steps were taken:
1) Four rectangular rings (A′, B′, C′, D′) of frit were deposited on the Gas Interface Manifold 100 in the pattern shown in FIG. 7B. In this embodiment, each of the frit rings was centered around one of four openings 112A, 112B, 112C, 112D on the side 110B of the Gas Interface Manifold 100. The GIM 100 with the rings was fired at 825 C for 2 hours, such that the glass-ceramic remained substantially glassy.
2) Frit paste layers were applied to the “inner” rings of the adaptor gasket 130, on one side of the gasket. While the paste was still wet, the gasket was mated to the Device Array Monolith 10 of Example 1, taking care that each ring surrounded one of the four gas ports on the base of the Device Array Monolith. The Device Array Monolith 10 with gasket 130 attached thereto was placed in an alumina fiberboard jig to hold the Device Array Monolith 10 vertical during the firing process. The gasket 130 was then permanently bonded to the Device Array Monolith 10 by sintering bonding the frit at a temperature of 825° C. for 2 hours.
3) Frit paste layers were applied to Gas Interface Manifold 100 on top of the glassy rings A′, B′, C′, D′). The Device Array Monolith 10 with the attached adaptor gasket 130 was mated by aligning the gasket rings to the wet paste layers. The combined assemblage was fired at 900° C. for 2 hours to sinter and crystallize the frit.
4) The feed tubes (supply tubing) 98A and 98B were inserted into the openings 122A, 122B of their respective endcaps to complete the fuel cell assembly. The completed structure is illustrated in FIG. 9.

### Example 2

The internally manifolded device array monolith 10 of this and other embodiments of the design offers outstanding gravimetric and volumetric power density potential. The power output of the device array monolith 10 is a function of a number of parameters including cell power density, active cell area per device, and the number of devices in the device array monolith 10. Gravimetric power density is the power output divided by the device array monolith 10 mass, and is principally a function of the frit bead weight used in construction of the device array monolith 10. Volumetric power density is power output divided by device array monolith 10 volume, and is principally a function of the device to device spacing.

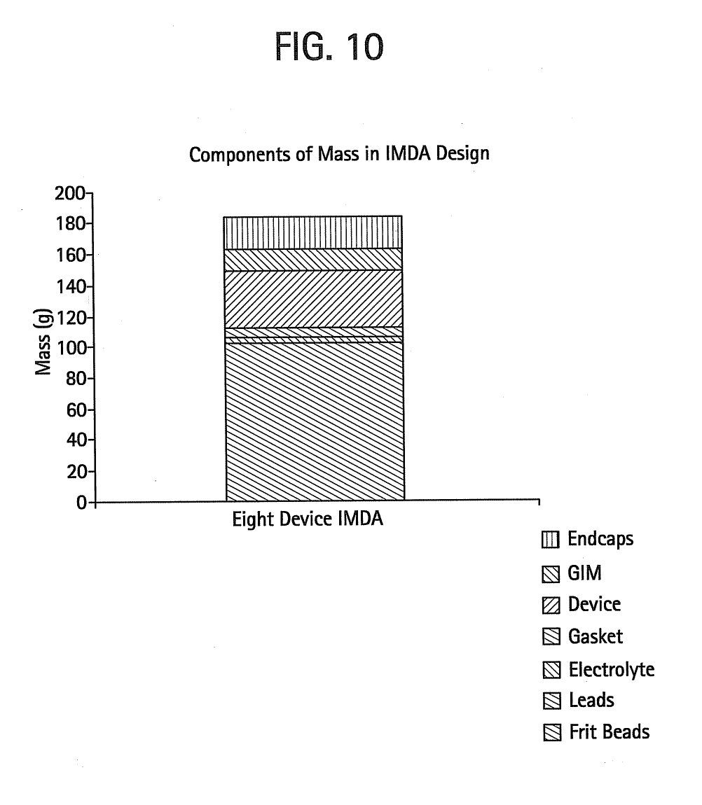

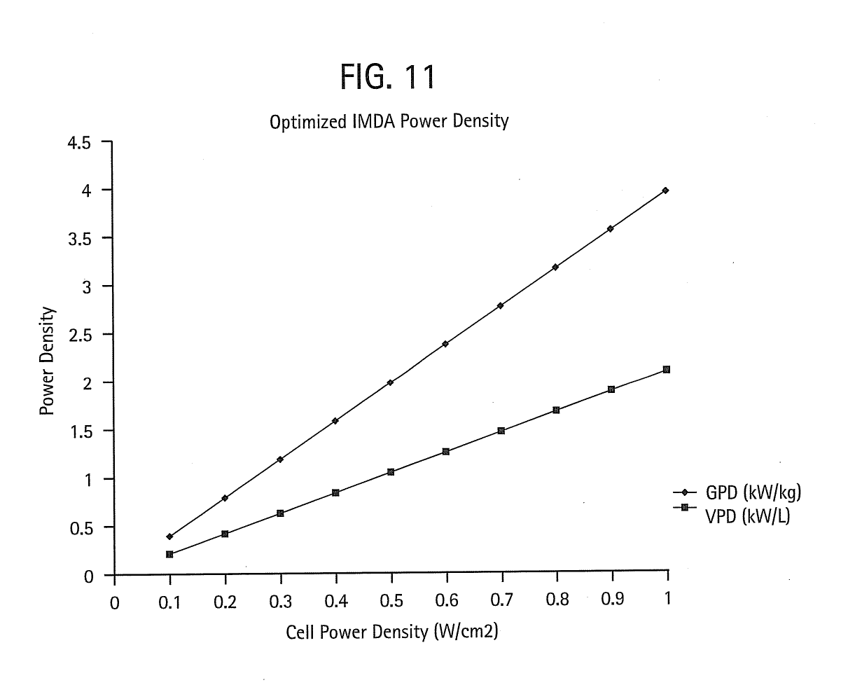

The device array monolith 10 shown schematically in FIG. 9 includes eight 12 cm×15 cm fuel cell devices 15 sandwiched between two 12 cm×15 cm electrolyte sheets 20. The fuel cell devices 15 and the electrolyte sheets 20 are joined by sintered frit. The contributions of various components of the DAM 10 of this embodiment to the mass of the DAM 10 is illustrated in FIG. 10. The DAM 10 corresponding to FIG. 10 has: a total of 8 fuel cell devices 15, volume of 346 cm³, device separation d=2 mm, total weight of 183 gms, and 90 cm² active area/per fuel cell device 15. FIG. 11 illustrates the relationship of gravimetric power density GPD and volumetric power density VPD as a function of cell power density. The specific heat for this model is 654 J/kg-Kand the fuel is gasoline. The model assumed that there was no heat loss. Exceptionally high power densities of 1 kW/L and 2 kW/kg are achievable at a typical cell power density of 0.5 W/cm² with this device array monolith design. This is due to the large cell area available per unit weight (3.93 cm²/g) and per unit volume (2.08 cm²/cm³).

The DAM 10 of this embodiment is connected to a gas interface manifold and is housed within a thermally insulating structure.

further comprising a thermally insulating structure surrounding said assembly.

### Example 3

The lightweight design of device array monolith 10 is well suited for use in portable applications including mobile vehicles. For vehicle application, some of the important parameters are start-up time and fuel penalty. As noted previously, in the embodiments descried herein the start-up time is improved, due to improved thermal shock tolerance inherent with a low thermal mass mismatch between the frame and devices in the device array monoliths. Fuel penalty is largely determined by the stack heat device array monoliths 10. In a simple model which neglects heat loss from the stack as a first approximation, the following relation holds for mass of fuel required to heat the stack to operating temperature:

$${m}_{f} = \frac{{{n}_{DAM} ( {mC}_{p} )}_{DAM}}{\frac{{LHV}_{f}}{T - {T}_{∞}} - ( 1 + AFR ) {C}_{p , air}}$$

where: m_{f} is the mass of fuel/gasoline (grams); n_{DAM} is the number of device array monoliths in stack; (mCₚ)_{DAM} is the heat capacity of device array monolith (J/K); LHV_{f} is Lower Heating Value of the Fuel (Gasoline@ 42 MJ/kg); T is the target temperature (e.g., 730° C.); Ta is Ambient Temperature (20° C.); AFR is Air/Fuel Ratio (Gasoline @ 14.7 kg-air/kg-fuel) and C_{p,air} is Specific Heat of Air (1040 J/kg-K)

Specific heat capacities for common DAM materials of construction are listed in Table 3.

TABLE 3

| Material | Specfic heat capacity | |
|---|---|---|
| 129NTR | 847 | J/kg-K |
| Ag | 233 | J/kg-K |
| 3YSZ | 611 | J/kg-K |

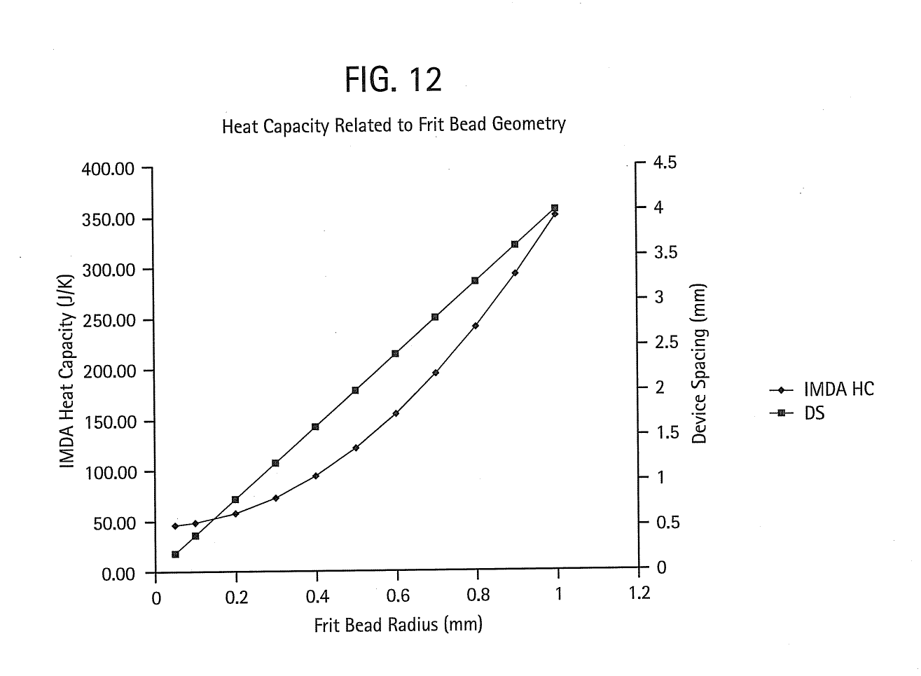

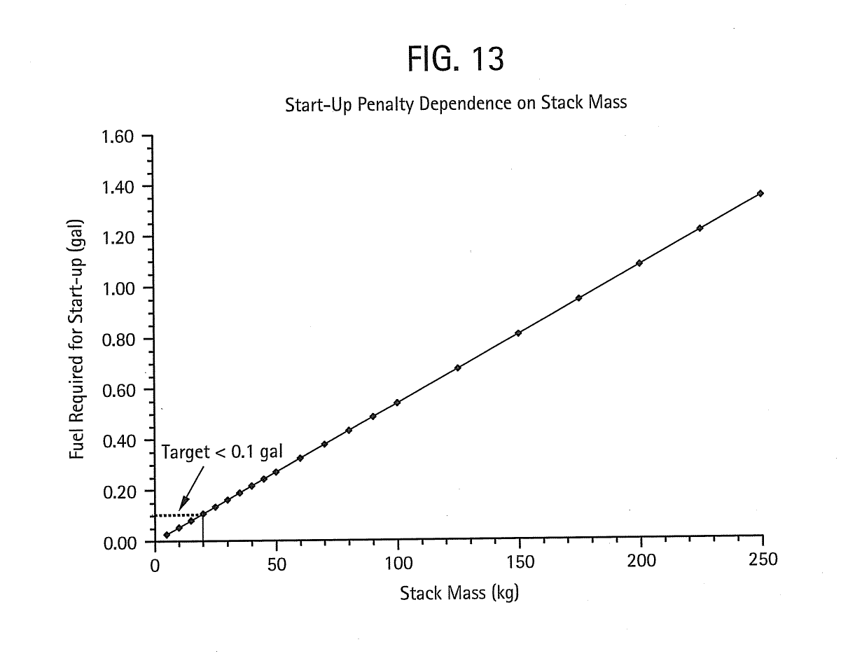

For the eight device DAM 10 of Example 2, the heat capacity is principally a function of frit bead mass. A simple model can relate heat capacity of the DAM to flit bead geometry by approximating the bead cross-section geometry as a half-circle for beads in contact with a device surface, or as circular for beads sandwiched between two adjacent frit bead layers. FIG. 12 shows the relationship between frit bead geometry, DAM heat capacity, and device (or fuel sheet) spacing. In this figure, the straight-line plot corresponds to ye IMPDA heat capacity (IMPDA HC), while the curved pot corresponds to t device spacing (DS). It is estimated that a spacing d of about 1 mm to 2 mm between fuel cell devises 15 is preferable for optimum gas flow pressure and uniform distribution. At a frit bead radius of 0.38 mm, the device spacing d is 1.5 mm and the DAM specific heat capacity is 654 J/kg-K. FIG. 13 shows the relationship between stack mass and start-up fuel volume penalty for a DAM 10 with a specific heat capacity of 654 J/kgK.

An attractive target for the energy required to heat a stack to operating temperature in a gasoline-powered automotive SOFC is less than 0.1 gal of fuel. To achieve a target fuel penalty of less than 0.1 gal of gasoline, a stack with heated mass less than about 20 kg is required. To achieve a 50 kW output at 20 kg requires a gravimetric power density of 2.5 kW/kg for the IMDA. Referring to FIG. 9, an internally manifolded DAM 10 would require a cell power density slightly over 0.6 W/cm² to reach a DAM gravimetric density of 2.5 kW/kg.

An alternative approach to lowering the fuel required for stack heat up is to segment the stack into thermally independent subunits and heat-up the subunits in a cascading fashion, wherein waste heat from one subunit may be used to heat other segments, without penalty. For example one or more fuel cell monoliths may correspond to each subunit and wherein the fuel cell device monoliths are arranged or situated to provide cascaded startup. Of course there will be an optimal interplay of startup time and fuel-penalty which will drive the best choice for design of stack segmentation, start-up penalty and drive cycle requirements.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A fuel cell device array monolith comprising:
at least three planar electrolyte sheets, at least one of said electrolyte sheets supporting a plurality of electrodes; said electrolyte sheets are joined together by sintered frit, without any metal frames or bipolar plates situated therebetween.

2. The fuel cell device array monolith of claim 1, wherein said at least one electrolyte sheet supports: (i) a plurality of anodes situated on one side of the electrolyte sheet; and (ii) plurality of cathodes situated on the other side of the electrolyte sheet.

3. A fuel cell device monolith comprising:
at least three planar electrolyte-supported fuel cell devices, each of said fuel cell devices including (i) an electrolyte sheet having two sides; (ii) a plurality of anodes situated on one side of the electrolyte sheet; and (iii) plurality of cathodes situated on the other side of the electrolyte sheet; said arrays being arranged such that an anode side of one fuel cell array faces the anode side of another fuel cell array and one cathode side of one fuel cell array faces the cathode side of another fuel cell array, and said at least three fuel cell arrays are directly joined to each other by sintered frit.

4. The fuel cell device monolith according to claim 3, wherein there are no metal frames or bipolar plates situated between said fuel cell devices.

5. The fuel cell device monolith according to claim 3, wherein said at least three fuel cell array share a common gas input port.

6. The fuel cell device monolith according to claim 3, wherein said sintered frit is a sintered frit structure that provides hermetic gas separation between said fuel cell devices.

7. The fuel cell fuel cell device monolith according to claim 3, wherein said sintered frit is a sintered frit structure that at least partially forms one or more of the following components: reactant gas flow passages, gas manifolds, restrictions for improving gas flow uniformity, and gas input and output orifices.

8. The fuel cell device monolith according to claim 3 or 4, wherein said fuel cell device monolith includes gas input and output ports situated on the same side of said fuel cell device monolith.

9. The fuel cell assembly comprising: the fuel cell device monolith according to claim 3, wherein said fuel cell assembly further comprises sintered gas interface manifold connected to said fuel cell device monolith.

10. The fuel cell assembly according to claim 9, wherein said gas interface manifold is connected to more than one orifice within said device monolith.

11. The fuel assembly according to claim 9, wherein said fuel cell device monolith includes gas input and output ports situated on the same side of said fuel cell device monolith, and said ports are connected to at least one side of the gas interface manifold.

12. A fuel cell device monolith according to claim 9 wherein said gas interface manifold is made of glass, ceramic or glass-ceramic extrudate.

13. The fuel cell assembly of claim 9, wherein said fuel cell assembly has a gravimetric power density at least 1 kW/kg.

14. The fuel cell fuel cell device monolith according to claim 1 or 3 wherein said fuel cell stack assembly has a volumetric power density at least 1 kW/liter.

15. The fuel cell device monolith 3 wherein said fuel cell device monolith has an active cell area per unit volume of at least 1 cm²/cm³.

16. The fuel cell assembly according to claims 1-9, wherein startup time of said fuel cell assembly is less than 10 minutes.

17. A fuel cell assembly according to claim 9, wherein the gas interface manifold is connected to the fuel cell device monolith with glass or sintered glass-ceramic frit.

18. A fuel cell stack comprising multiple fuel device monoliths according to claim 3, wherein said fuel cell device monoliths are arranged for cascaded startup.

19. A fuel cell assembly according to claim 9 further comprising a thermally insulating structure surrounding said assembly.

20. A method for producing a fuel cell stack assembly comprising the steps of: (i) producing at lest three fuel cell devices comprising an electrolyte sheet; (ii) patterning a surface of at lest two of said devices with glass, glass-ceramic or ceramic based material, thereby producing a plurality of patterned device; (iii) sintering each of said patterned devices to at least one other device so as to permanently attach said three devices to one another with a sintered glass, glass-ceramic or ceramic based material, such that there are no metal frames or bipolar plates situated therebetween.
